(19) United States
(12) Patent Application Publication
(10) Pub. No.: US 2020/0022086 A1
(43) Pub. Date: Jan. 16, 2020

(54) USER EQUIPMENT WITH ADAPTIVE TRANSMISSION POWER SCALING BASED ON DECODING CONFIDENCE

(71) Applicant: Intel IP Corporation, Santa Clara, CA (US)

(72) Inventors: Zhibin Yu, Unterhaching (DE); Narayan Vishwanathan, San Diego, CA (US); Wei Jiang, Xi'an (CN); Thomas Fliess, Dresden (DE); Ziyang Ju, Munich (DE)

(21) Appl. No.: 16/484,325

(22) PCT Filed: Jan. 15, 2018
(86) PCT No.: PCT/EP2018/050871

§ 371 Date: Aug. 7, 2019

(30) Foreign Application Priority Data
Feb. 14, 2017 (EP) 17155980.0

(51) Int. Cl. H04W 52/14; H04W 52/34; H04W 52/26; H04W 72/04; H04W 52/22; H04W 52/48

(52) U.S. Cl. CPC H04W 52/146; H04W 52/346; H04W 52/48; H04W 72/0413; H04W 52/22; H04W 52/262

(57) ABSTRACT

This disclosure relates to a User Equipment (UE), comprising: a transceiver, configured to receive a Downlink (DL) transmission from a base station (BS) and to transmit an Uplink (UL) transmission to the BS; and a controller, configured to determine a decoding confidence of the BS based on a decoding confidence metric with respect to the received DL transmission and to generate a power scaling for the UL transmission based on the determined decoding confidence, wherein the transceiver is configured to transmit the UL transmission based on the power scaling generated by the controller.

### FIELD

The disclosure relates to a user equipment (UE) with uplink power scaling based on a decoding confidence of a base station (BS) and a method for power scaling of a UE. The disclosure particularly relates to techniques of adaptive transmission power scalings based on UCI (Uplink Control Information) decoding confidence estimation for LTE (Long Term Evolution) uplink carrier aggregations.

### BACKGROUND

In Wireless Networks uplink carrier aggregation can be configured for uplink transmissions on both the primary carrier and the secondary carrier on the same subframe. The Uplink transmission power over each cell follows a specified power control procedure which may result in different power levels on the primary and secondary cells in the same subframe where the total power is constrained. There are situations in which the requested transmission power for high priority carriers is already close to or even exceeds the total power constraint. Then, there is no power budget left for the low priority carriers at all. The result is that the low priority carriers are potentially not heard by the eNB (base station) at all.

Hence, there is a need to provide a concept for an efficient power scaling to avoid the above described situations.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description.

FIG. 1a is a high level block diagram of a mobile device architecture and base station.

FIG. 1b is a high level block diagram of a user equipment (UE) 100 according to the disclosure.

FIG. 2 is a block diagram illustrating a UCI decoding confidence estimator module 200 according to an implementation form.

FIG. 3 is a schematic diagram illustrating the control flow for an adaptive transmission power scaling controller module 300 according to an implementation form.

FIG. 4 is a block diagram of a User Equipment (UE) 400 according to an implementation form.

FIG. 5 is a schematic diagram of a method 500 for power scaling of a User Equipment (UE) according to an implementation form.

### DETAILED DESCRIPTION

In the following detailed description, reference is made to the accompanying drawings, which form a part thereof, and in which is shown by way of illustration specific aspects in which the invention may be practiced. It is understood that other aspects may be utilized and structural or logical changes may be made without departing from the scope of the present invention. The following detailed description, therefore, is not to be taken in a limiting sense, and the scope of the present invention is defined by the appended claims. The following terms, abbreviations and notations will be used herein:

### UCI: Uplink Control Information

### DCI: Downlink Control Information

### CA: Carrier Aggregation

Pcell: Primary Cell (of carrier aggregation)
Scell: Secondary Cell (of carrier aggregation)

### PMI: Precoding Matrix Indicator

### RI: Rank Indicator

### CQI: Channel Quality Indicator

### NDI: New Data Indicator

### HARQ: Hybrid Automatic Repeat Request

### ACK/NACK Acknowledgement/Non-Acknowledgement

### RF: Radio Frequency

### MCS: Modulation and Coding Scheme

UE: User Equipment, cellular handset
eNB, BS: Base Station

### LTE: Long Term Evolution

### PUSCH: Physical Uplink Shared Channel

### UL: Uplink

### DL: Downlink

### HW: Hardware

### SW: Software

It is understood that comments made in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

The techniques described herein may be implemented in wireless communication networks, in particular communication networks based on mobile communication standards such as LTE, in particular LTE-A and/or OFDM and successor standards such as 5G. The methods are also applicable for high speed communication standards from the 802.11 family according to the WiFi alliance, e.g. 802.11ad and successor standards. The methods and devices described below may be implemented in electronic devices such as cellular handsets, mobile or wireless devices (or mobile stations or User Equipments (UE)). The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense.

The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

In the following techniques for power scaling are described that may be implemented for LTE uplink carrier aggregation. For LTE uplink carrier aggregation, LTE UE can be scheduled by the eNB for uplink transmissions over PUSCH (Physical Uplink Shared Channel) on both the primary carrier and the secondary carriers on the same subframe when Uplink carrier aggregation is enabled. The Uplink transmission power over each cell follows the power control procedure specified in section 5.1.1.1 of 3GPP technical specification TS 36.213. This could result in different power levels on the primary and secondary cells in the same subframe. However the total power from the UE is always constrained to satisfy the limits of total configured maximum output power P_{CMAX} where P_{CMAX} is defined in section 6.2.5A of 3GPP technical specification TS 36.101. In power limited scenarios, the combined requested power over both carriers could exceed the limits of P_{CMAX}. In such cases section 5.1.1.1 of technical specification TS 36.213 specifies the priority rules to scale down the individual powers per cell such that the sum of the scaled power per cell is below P_{CMAX}. The goal is that the cell carrying UCI is prioritized with higher transmission power than the cells without UCI.

The priority can be defined as follows: PUSCH transmission Cell with UCI>PUSCH transmission Cell without UCI, where UCI means uplink control information (including DL ACK/NACK feedbacks and CSI feedbacks).

The problem is that, when the requested transmission power for high priority carriers are already close to or even exceeds P_{CMAX}, then there is no power budget left for applying down-power scaling for the low priority carriers at all. The result is that the down-scaled low priority carriers are potentially not heard by eNB at all. As an example suppose the UE is configured with carrier aggregation on the Uplink with one primary cell (PCell) and one secondary cell (Scell). In a case where the transmission power on the primary carrier reaches P_{CMAX} and PUSCH on the primary carrier contains UCI applying the full scaling priority results in no transmission power left for the UE to allocate to the secondary carrier. Thus, the secondary carrier is effectively blanked which would drastically reduce the throughput (UL throughput drop can be up-to 50%).

In this specific case, 3GPP standard reserves certain flexibility for UE implementation such that UE can partially down-scale the transmission power of high priority cells so that low priority cells still get partial transmission power. This avoids significant drop of UL throughput. However, the problem is how to find the optimal tradeoff: If UE allocates too little power to low priority cells, the UL throughput will still be bad due to low SINR of low priority cells. But if UE allocates too much power for low priority cells without UCI information, then it will degrade the UCI decoding performance in the eNB side, which will result in huge performance degradation for DL. Applying the hereinafter presented techniques for power scaling provides an optimal tradeoff for maintaining high transmission power for high priority cells and still providing partial transmission power for low priority cells.

The main idea is to use an adaptive transmission power scaling approach for the carrier with UCI wherein the adaptation is based on an UE estimated UCI decoding confidence level for the eNB side: When UE estimates that very few UCI decoding failings (high confidence) in eNB, then more transmission power may be allocated from PCell transmission (with UCI) to SCell transmission (without UCI). When UE estimates that massive UCI decoding failings (low confidence) in eNB side, then UE should fully prioritize the transmission to PCell to minimize the impacts on DL performance, while at the same time allocating less or even no transmission power to SCell.

The UCI decoding confidence estimation can be performed by monitoring DL behaviors which can be correlated with “wrongly decoded UCIs” in eNB side. For example, UE can apply the following metrics:

A first metric that may be applied evaluates the counter of unexpected DL retransmission requests which indicates DL ACK/NACK feedback is not being successfully decoded by eNB.

A second metric that may be applied evaluates the counter of instances when eNB did not follow PMI or RI reports sent by UE. According to field experience, eNB always follows PMI/RI requests if it successfully decodes PMI/RI bits.

A third metric that may be applied evaluates the counter of instances when eNB schedules an over-optimistic MCS allocation (i.e., a very high MCS although UE previously reports a very poor CQI). In the field eNB does not always follow CQI reports, for example for traffic balancing purpose even UE is in good channel conditions and has high CQI reports, it could still be allocated with low MCS. However, an over-optimistic MCS allocation still lowers down confidence of correct decoding of CQI reports in eNB side.

Note that UCIs are usually not protected by CRC (cyclic redundancy check). I.e. there is no CRC for ACK/NACK or RI, CRC for PMI/CQI only if it exceeds certain number of bits. Therefore, eNB usually does not know if it decodes UCI wrongly, this makes the power scaling according to this disclosure valuable because UE can estimate the failings by the herein presented techniques.

Based on the above metrics UE can form a combined estimate of the UCI decoding confidence level for the eNB, and can further use that estimate to determine its power scaling. Instead of using a fixed power allocation scheme which has a high penalty on the UL traffic, the scheme disclosed hereinafter can maximize UL throughput while minimizing impact on DL throughput.

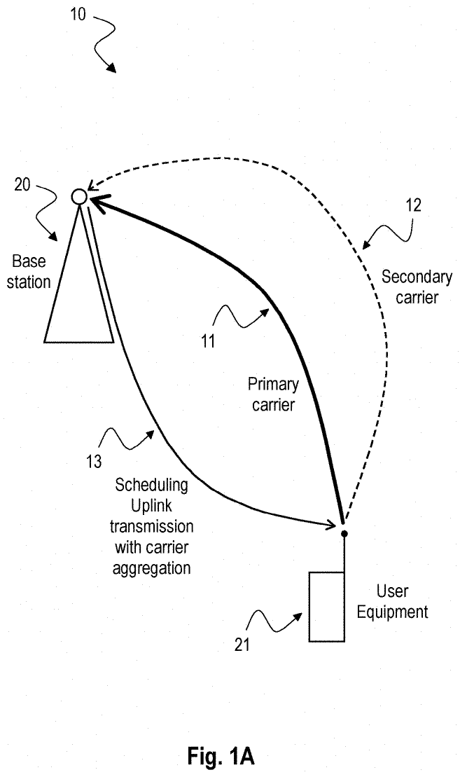

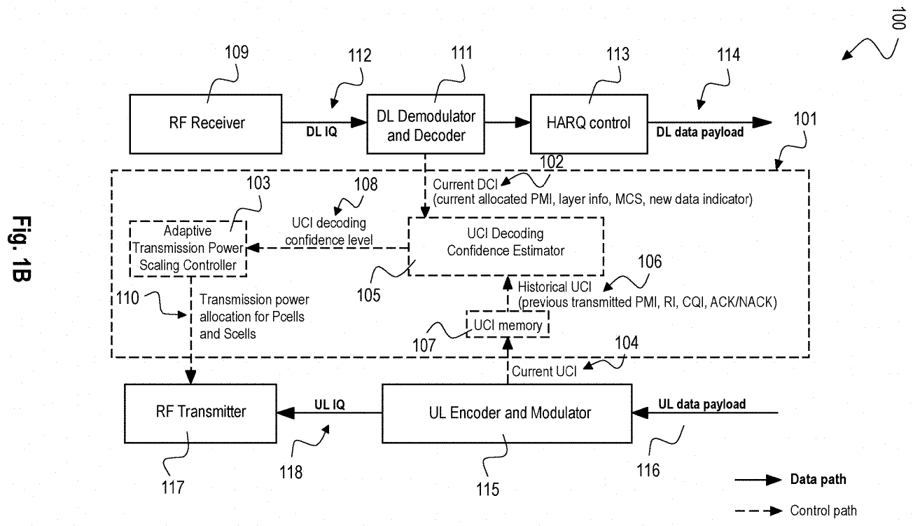

FIG. 1a is a high level block diagram 10 of a mobile device architecture and base station. The base station 20 can schedule 13 uplink transmission with carrier aggregation on the user equipment 21 for uplink transmissions on both the primary carrier 11 and the secondary carrier 12 on the same subframe. The Uplink transmission power over each cell follows a specified power control procedure which may result in different power levels on the primary and secondary cells in the same subframe where the total power is constrained. The base station 20 can configure the uplink transmission power such that situations in which the requested transmission power for high priority carriers is already close to or even exceeds the total power constraint can be avoided as described in the following. The base station 20 can configure the uplink power transmission in order to leave a power budget for the low priority carriers, e.g. the secondary carrier 12 as exemplary depicted in FIG. 1a.

FIG. 1b is a high level block diagram of a user equipment (UE) 100 according to the disclosure. The UE 100 includes a receive path 109, 111, 113 with a radio frequency (RF) receiver 109 for receiving a downlink (DL) transmission, e.g. from a base station. The RF receiver 109 provides DL in-phase quadrature (IQ) data 112 to a DL demodulator and decoder 111 that demodulates and decodes the DL IQ data 112 to derive (current) DL control information (DCI) 102 from the DL IQ data 112. A HARQ (hybrid automatic repeat request) block 113 is coupled to the output of the DL demodulator and decoder 111 to provide DL data payload 114.

The UE 100 includes a transmit path 115, 117 with an uplink (UL) encoder and modulator 115 to encode and modulate UL data payload 116 in order to provide UL IQ data 118 to an RF transmitter 117 that transmits an uplink transmission which transmission power is adjusted by a power scaling 110.

The UE 100 further includes a control path 103, 105, 107 with a UCI decoding confidence estimator 105 that provides a UCI decoding confidence level 108 based on historical UCI data retrieved from a UCI memory 107 and current DCI data provided by the DL demodulator and decoder 111. The UCI memory 107 stores current UCI values provided by the UL encoder and modulator 115. The UCI memory 107 thus stores current and past UCI values that form the historical UCI values 106. The historical UCI values 106 may include previous transmitted PMI, RI, CQI and/or, ACK/NACK. The control path further includes an adaptive transmission power scaling controller 103 that generates a power scaling 110, e.g. a transmission power allocation for primary cells (Pcells) and secondary cells (Scells) when UL carrier aggregation is enabled, based on the UCI decoding confidence level 108 provided by the UCI decoding confidence estimator 105. The power scaling 110 is used to scale the transmission power of the RF transmitter 117.

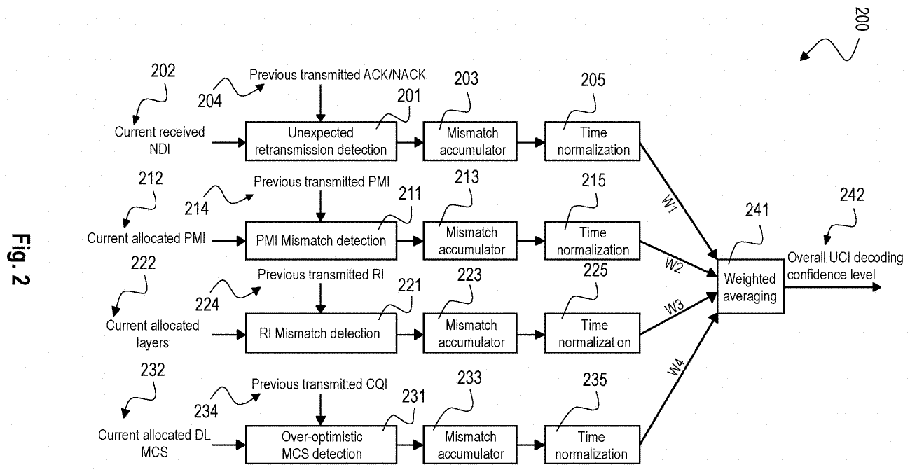

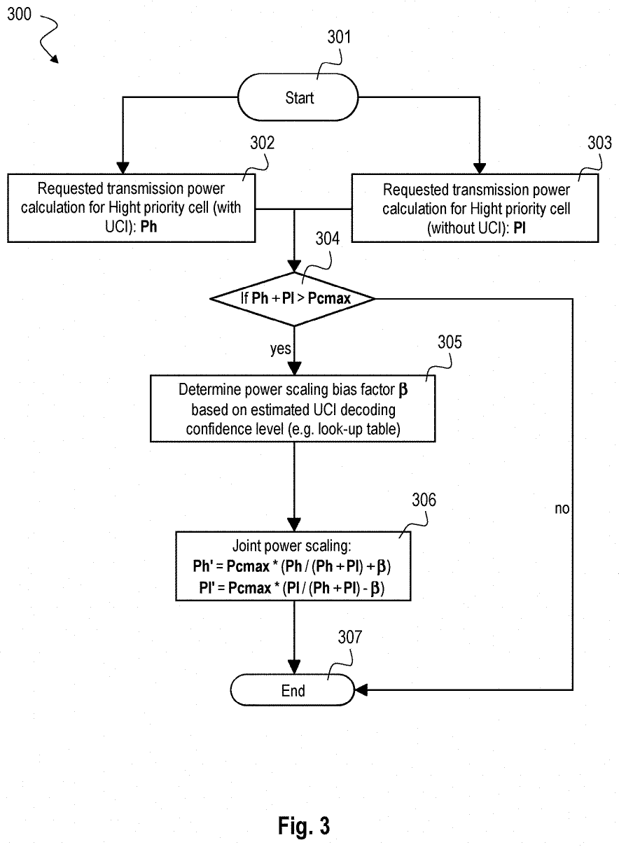

An exemplary implementation of the UCI decoding confidence estimator 105 is described below with respect to FIG. 2. An exemplary implementation of the adaptive transmission power scaling controller 103 is described below with respect to FIG. 3.

In the UL transmitter 117, the UCI containing PMI, RI, CQI, ACK/NACK information generated by the DL receiver 109 is transmitted to eNB, but also at the same time the UCI is stored into the UCI memory 107.

In the DL receiver 109, downlink control information (DCI) is decoded which contains the allocated precoding matrix information (correlated with previously reported PMI), downlink layer information (correlated with previously reported RI), MCS (correlated with previously reported CQI) and NDI (new data indicator for DL retransmissions, correlated with previously reported ACK/NACK). The DCI information is given to the UCI decoding confidence level estimator module 105. Meanwhile, the estimator module 105 also reads the previous UCI 106 from UCI memory 107, which should be mapped to the current DL control information 102.

The UCI decoding confidence estimator module 105 evaluates the correlations between the previously reported UCI 106 and actually currently allocated DCIs 102: e.g. calculate the statistics of “unexpected DL retransmission requests” by comparing previously reported ACK/NACK in UCI 106 with current indicated NDI in DCI 102; or (and) calculate the statistics of “unexpected RI” by comparing the assigned DL layers with previously reported RI; or (and) calculate the statistics of “unexpected PMI” by comparing previously reported PMI with current allocated DL pre-coding matrix. The statistics can be generated by a mismatch counter averaged by time, e.g. using a mismatch accumulator 203, 213, 223, 233 as described below with respect to FIG. 2. In particular, for CQI reports, although eNB does not need to strictly follow the reported CQI with the actual assigned MCS, still deeper exploration can be made by detecting the statistics of “over-optimistic DL MCS allocation”: e.g. UE reported a very low CQI but eNB still assigns very high MCS, this observation may be used to lower down the UCI decoding confidence level. In the end, the statistics of each evaluation path can be weighted and combined to generate an overall estimate of the UCI decoding result on the eNB, e.g. by using the weighted averaging module 241 described below with respect to FIG. 2. One implementation for the estimator module 105 is shown and described below in FIG. 2.

A prediction filter (IIR or FIR type) can be implemented on top, to combine the historical estimated confidence level with current estimated confidence level 108, this will smooth scaling bias change and will also enable faster tracking of field channel condition change.

The estimated (or predicted) UCI decoding confidence level 108 can now be used inside the transmission power scaling control module 103 to apply a bias factor, e.g. as described below with respect to FIG. 3. When the above estimated confidence level 108 indicates low error rate on UCI decoding, the bias factor may be close to 0 which results in a maximum power of P_{CMAX}/2 for each carrier. Thus no special priority may be given to the carrier with UCI since UE estimates that UCI is successfully decoded with a high probability on eNB. When the estimated confidence level 108 indicates high error rate of UCI decoding on eNB, the bias may tend towards 1 which means power of P_{CMAX} is given to carrier with UCI which is similar to the existing 3GPP scheme.

The control path 103, 105, 107 can be implemented by only changing control software of a common UE, no hardware changes are required. The UCI memory 107 and the “wrongly decoded UCI” detector 105 can be implemented in L1CC SW (layer 1 control core software), which already has the information for both UCI and DCI. The adaptive transmission power control module 103 can be merged into LTX transmission power control SW which calculates the actual transmission power for each carrier and provides this to RF transmitter 117.

Implementing such a control path in a UE increases the LTE UL performance for LTE modems, i.e. smoother and overall higher UL throughput for UL-CA case can be achieved, while carefully protecting LTE DL performance.

FIG. 2 is a block diagram illustrating a UCI decoding confidence estimator module 200 according to an implementation form.

The UCI decoding confidence estimator module 200 includes an exemplary number of four input paths for evaluating contributions of different components of the UCI 106, e.g. for evaluating current received NDI (new data indicator) 202, current allocated PMI (precoding matrix indicator) 212, current allocated layers 222 and current allocated DL MCS (downlink modulation and coding scheme) 232.

In the first input path, an unexpected retransmission detection module 201 compares the current received NDI 202 against previous transmitted ACK/NACK (Acknowledgemts/Non-Acknowledgements) 204 to provide mismatches which are counted by a mismatch accumulator 203 and normalized by a time normalization module 205 to provide a first weight W1.

In the second input path, a PMI mismatch detection module 211 compares the current allocated PMI 212 against previous transmitted PMI 214 to provide mismatches which are counted by a mismatch accumulator 213 and normalized by a time normalization module 215 to provide a second weight W2.

In the third input path, a RI mismatch detection module 221 compares the current allocated layers 222 against previous transmitted RI 224 to provide mismatches which are counted by a mismatch accumulator 223 and normalized by a time normalization module 225 to provide a third weight W3.

In the fourth input path, an over-optimistic MCS detection module 231 compares the current allocated DL MCS 232 against previous transmitted CQI 234 to provide mismatches which are counted by a mismatch accumulator 233 and normalized by a time normalization module 235 to provide a fourth weight W4.

The UCI decoding confidence estimator module 200 further includes a weighted averaging module 241 that weights and averages the four weights W1, W2, W3 and W4 received from the four input paths to provide an overall UCI decoding confidence level 242 that may correspond to the UCI decoding confidence level 108 described above with respect to FIG. 1b.

FIG. 3 is a schematic diagram illustrating an exemplary control flow for an adaptive transmission power scaling controller module 300 according to an implementation form.

After start 301 either transmission power calculation is requested 302 for high priority cell Ph (with UCI), also referred to as primary cell, or transmission power calculation is requested 303 for low priority cell P1 (without UCI), also referred to as secondary cell. For both cases a check module 304 checks if the sum of Ph and P1 is above Pcmax. If not, the control flow ends 307. If yes, a power scaling bias factor 3, is determined 305 based on estimated UCI decoding confidence level, e.g. by applying a look-up table. Then, a joint power scaling 306 is performed according to the formulas: Ph′=Pcmax*(Ph/(Ph+P1)+β) and P1′=Pcmax*(P1/(Ph+P1)−β) and the control flow ends 307. Ph′ is the updated high priority cell and P1′ is the updated low priority cell P1. These power scaling factors may correspond to the transmission power allocation 110 for Pcells and Scells described above with respect to FIG. 1b.

With respect to FIG. 3, the estimated UCI decoding confidence level (108 according to FIG. 1b or 242 according to FIG. 2) can be mapped to a power scaling bias factor β (this mapping can be done through a look-up table operation), which gives the bias term for the adaptive transmission power scaling formulas described above: when the estimated confidence level indicates low error rate on UCI decoding, lower β is selected so that more transmission power is allocated to low priority cell (P1′, without UCI), this protects the UL throughput; When the estimated confidence level indicates high error rate of UCI decoding on eNB, higher β is selected so that more transmission power is allocated to high priority cell (Ph′, with UCI). This protects UCI decoding and thus also the DL throughput.

In particular, there are two extreme cases: In a first extreme case, the result is Ph′=Pmax which gives full UCI protection. In a second extreme case, the result is equal scaling between Ph and P1 which is optimal for UL throughput.

The disclosed concept can also be extended for UL payload data robustness improvement. That is done by adaptive transmission power scaling based on the requested UL retransmissions, when the eNB requested transmission power sum exceeds Pcmax.

The disclosed concept can also be extended for other LTE multi-carrier transmission scenarios, for example Dual SIM Dual Active (DSDA), when the requested transmission power sum of two SIMs exceeds Pcmax.

The disclosed concept is shown in FIG. 3 for the case of 2 Uplink carriers aggregation but can easily be extended for more than 2 aggregated carriers in the Uplink.

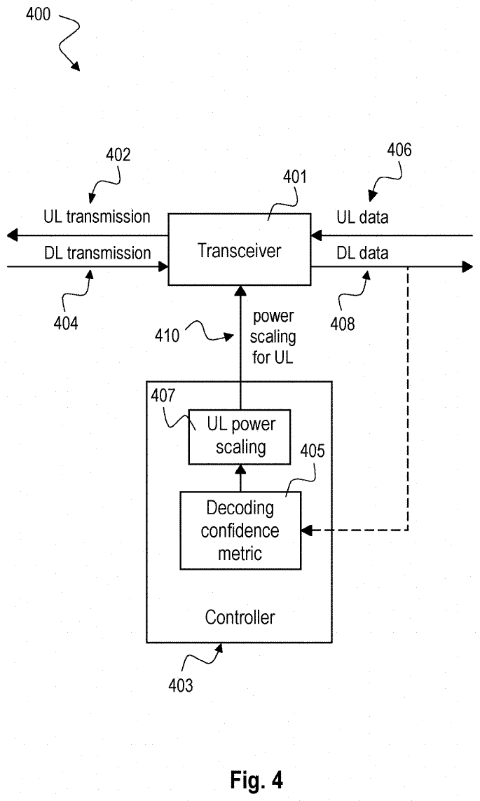

FIG. 4 is a block diagram of a User Equipment (UE) 400 according to an implementation form. The UE 400 includes a transceiver 401 and a controller 403. The transceiver 401 is configured to receive a Downlink (DL) transmission 404 from a base station (BS) and to transmit an Uplink (UL) transmission 402 to the BS. The controller 403 is configured to determine a decoding confidence of the BS based on a decoding confidence metric 405 with respect to the received DL transmission 408 (in particular DL data 408 derived from the DL transmission 404) and to generate 407 a power scaling 410 for the UL transmission 402 (in particular for UL data 406 for forming the UL transmission 402) based on the determined decoding confidence. The transceiver 401 is configured to transmit the UL transmission 402 based on the power scaling 410 generated by the controller 403.

The transceiver 401 may correspond to the blocks RF Receiver 109 and RF transmitter 117 described above with respect to FIG. 1b and may additionally include the blocks DL Demodulator and Decoder 111 and UL Encoder and Modulator 115 described above with respect to FIG. 1b.

The decoding confidence metric 405 may be based on counting unexpected DL retransmission requests, e.g. as described above with respect to FIGS. 1 to 3.

The decoding confidence metric may be based on counting instances when the BS did not follow one of precoding matrix indication (PMI) or rank indication (RI) reports sent by the UE, e.g. as described above with respect to FIGS. 1 to 3. The decoding confidence metric may be based on counting instances when the BS schedules an over-optimistic modulation and coding set (MCS) allocation, e.g. as described above with respect to FIGS. 1 to 3.

The controller 403 may be configured to reduce the power scaling for the UL transmission when determining an increased decoding confidence of the BS and to increase the power scaling for the UL transmission when determining a reduced decoding confidence of the BS, e.g. as described above with respect to FIGS. 1 to 3.

The decoding confidence metric may be based on a confidence of decoding Uplink Control Information (UCI) by the BS, e.g. as described above with respect to FIGS. 1 to 3.

The transceiver 401 may be configured to transmit the UL transmission comprising the UCI unprotected by error correction coding, e.g. as described above with respect to FIGS. 1 to 3.

The controller 403 may be configured to generate the power scaling 410 in a carrier aggregation scenario for an UL transmission 402 comprising a first UL transmission directed to a primary cell and at least one secondary UL transmission directed to at least one secondary cell, wherein the first UL transmission carries the UCI, e.g. as described above with respect to FIGS. 1 to 3.

The controller 403 may be configured to down-scale the power scaling 410 for the first UL transmission and to upscale the power scaling 410 for the at least one secondary UL transmission when a total configured maximum output power of the UL transmission crosses a threshold, e.g. as described above with respect to FIGS. 1 to 3.

The controller 403 may be configured to reduce the power scaling 410 for the first UL transmission and to correspondingly increase the power scaling for the at least one secondary UL transmission when determining an increased decoding confidence of the BS and to increase the power scaling 410 for the first UL transmission and to correspondingly reduce the power scaling 410 for the at least one secondary UL transmission when determining a reduced decoding confidence of the BS, e.g. as described above with respect to FIGS. 1 to 3.

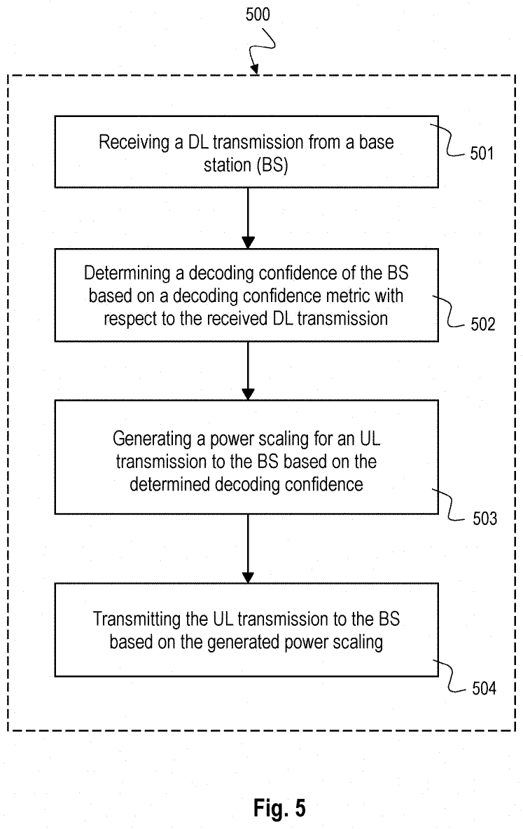

FIG. 5 is a schematic diagram of a method 500 for power scaling of a User Equipment (UE) according to an implementation form.

The method 500 includes receiving 500 a Downlink (DL) transmission from a base station (BS); determining 502 a decoding confidence of the BS based on a decoding confidence metric with respect to the received DL transmission; generating 503 a power scaling for an Uplink (UL) transmission to the BS based on the determined decoding confidence; and transmitting 504 the UL transmission to the BS based on the generated power scaling. The method 500 may implement the functionality of the UE 400 described above with respect to FIG. 4.

The decoding confidence may indicate a confidence of decoding an Uplink Control Information (UCI) by the BS, wherein the UCI is included in the UL transmission.

The decoding confidence metric may be based on Downlink Control Information (DCI) included in the DL transmission, e.g. as described above with respect to FIG. 4.

Determining 502 the decoding confidence may include determining unexpected DL retransmission requests based on a comparison of a previously reported Acknowledgement (ACK) or Non-Acknowledgement (NACK) in the UCI with a current indicated New Data Indicator (NDI) in the DCI, e.g. as described above with respect to FIG. 4.

Determining 502 the decoding confidence may include determining unexpected Rank Indicators (RIs) based on a comparison of assigned DL layers with previously reported RIs, e.g. as described above with respect to FIG. 4.

Determining 502 the decoding confidence may include determining unexpected Precoding Matrix Indicators (PMIs) based on a comparison of previous reported PMIs with a current allocated DL precoding matrix, e.g. as described above with respect to FIG. 4.

Determining 502 the decoding confidence may include determining an overoptimistic Modulation and Coding Scheme (MCS) allocation based on a comparison of a current allocated DL MCS with a previous transmitted Channel Quality Indicator (CQI), e.g. as described above with respect to FIG. 4.

The method 500 may further include: using respective mismatch counters for determining the unexpected DL retransmission requests, the unexpected RIs, the unexpected PMIs and the overoptimistic MCS allocation, e.g. as described above with respect to FIG. 4.

The method 500 may further include: determining an overall UCI decoding confidence level based on a combined weighted averaging of the respective mismatch counters.

The method 500 may further include: determining a power scaling bias factor based on the overall UCI decoding confidence level.

The power scaling bias factor may be close to zero when the overall UCI decoding confidence level indicates low error rate on UCI decoding and may be close to one when the overall UCI decoding confidence level indicates a high error rate on UCI decoding.

The method 500 may further include: predicting a future decoding confidence of the BS based on a combination of at least one previously determined decoding confidence of the BS and a currently determined decoding confidence of the BS.

The power scaling as presented in this disclosure can be checked by creating a lab setup where the UE is connected with cable (i.e. very good channel conditions available) to an eNB or an eNB simulator. eNB should be configured to set Uplink carrier aggregation on the UE. Once Uplink CA is activated the eNB continuously schedules uplink grants with fixed allocation (RBs) and MCS on both carriers and also schedules DL traffic on one or both carriers. eNB does not configure simultaneous PUCCH-PUSCH. As a result the primary cell PUSCH will carry UCI. Further the requested power on each cell can be forced to P_{CMAX} by sending TPC up commands from eNB. The power of PCell and SCell can be noted at this point. Then eNB can be forced to trigger DL retransmissions even if the UE reports ACK on the UL. If the observed PCell transmission power from the same UE is reduced compared to previous step, although the requested transmission power from eNB stays unchanged, the UE has correctly implemented the power scaling according to the disclosure.

The devices and systems described in this disclosure may be implemented as Digital Signal Processors (DSP), micro-controllers or any other side-processor or hardware circuit on a chip or an application specific integrated circuit (ASIC).

Embodiments described in this disclosure can be implemented in digital electronic circuitry, or in computer hardware, firmware, software, or in combinations thereof, e.g. in available hardware of mobile devices or in new hardware dedicated for processing the methods described herein.

The present disclosure also supports a computer program product including computer executable code or computer executable instructions that, when executed, causes at least one computer to execute the performing and computing blocks described herein, in particular the method 500 described above with respect to FIG. 5 and the computing blocks described above with respect to FIGS. 1 to 4. Such a computer program product may include a non-transient readable storage medium storing program code thereon for use by a processor, the program code comprising instructions for performing the methods or the computing blocks as described above.

### Examples

The following examples pertain to further embodiments. Example 1 is a User Equipment (UE), comprising: a transceiver, configured to receive a Downlink (DL) transmission from a base station (BS) and to transmit an Uplink (UL) transmission to the BS; and a controller, configured to determine a decoding confidence of the BS based on a decoding confidence metric with respect to the received DL transmission and to generate a power scaling for the UL transmission based on the determined decoding confidence, wherein the transceiver is configured to transmit the UL transmission based on the power scaling generated by the controller.

In Example 2, the subject matter of Example 1 can optionally include that the decoding confidence metric is based on counting unexpected DL retransmission requests.

In Example 3, the subject matter of any one of Examples 1-2 can optionally include that the decoding confidence metric is based on counting instances when the BS did not follow one of precoding matrix indication (PMI) or rank indication (RI) reports sent by the UE.

In Example 4, the subject matter of any one of Examples 1-3 can optionally include that the decoding confidence metric is based on counting instances when the BS schedules an over-optimistic modulation and coding set (MCS) allocation.

In Example 5, the subject matter of any one of Examples 1-4 can optionally include that the controller is configured to reduce the power scaling for the UL transmission when determining an increased decoding confidence of the BS and to increase the power scaling for the UL transmission when determining a reduced decoding confidence of the BS.

In Example 6, the subject matter of any one of Examples 1-5 can optionally include that the decoding confidence metric is based on a confidence of decoding Uplink Control Information (UCI) by the BS.

In Example 7, the subject matter of Example 6 can optionally include that the transceiver is configured to transmit the UL transmission comprising the UCI unprotected by error correction coding.

In Example 8, the subject matter of any one of Examples 6-7 can optionally include that the controller is configured to generate the power scaling in a carrier aggregation scenario for an UL transmission comprising a first UL transmission directed to a primary cell and at least one secondary UL transmission directed to at least one secondary cell, wherein the first UL transmission carries the UCI.

In Example 9, the subject matter of Example 8 can optionally include that the controller is configured to down-scale the power scaling for the first UL transmission and to upscale the power scaling for the at least one secondary UL transmission when a total configured maximum output power of the UL transmission crosses a threshold.

In Example 10, the subject matter of any one of Examples 8-9 can optionally include that the controller is configured to reduce the power scaling for the first UL transmission and to correspondingly increase the power scaling for the at least one secondary UL transmission when determining an increased decoding confidence of the BS and to increase the power scaling for the first UL transmission and to correspondingly reduce the power scaling for the at least one secondary UL transmission when determining a reduced decoding confidence of the BS.

Example 11 is a method for power scaling of a user equipment (UE), the method comprising: receiving a Downlink (DL) transmission from a base station (BS); determining a decoding confidence of the BS based on a decoding confidence metric with respect to the received DL transmission; generating a power scaling for an Uplink (UL) transmission to the BS based on the determined decoding confidence; and transmitting the UL transmission to the BS based on the generated power scaling.

In Example 12, the subject matter of Example 11 can optionally include that the decoding confidence indicates a confidence of decoding an Uplink Control Information (UCI) by the BS, the UCI comprised in the UL transmission.

In Example 13, the subject matter of Example 12 can optionally include that the decoding confidence metric is based on Downlink Control Information (DCI) comprised in the DL transmission.

In Example 14, the subject matter of Example 13 can optionally include that determining the decoding confidence comprises determining unexpected DL retransmission requests based on a comparison of a previously reported Acknowledgement (ACK) or Non-Acknowledgement (NACK) in the UCI with a current indicated New Data Indicator (NDI) in the DCI.

In Example 15, the subject matter of Example 14 can optionally include that determining the decoding confidence comprises determining unexpected Rank Indicators (RIs) based on a comparison of assigned DL layers with previously reported RIs.

In Example 16, the subject matter of Example 15 can optionally include that determining the decoding confidence comprises determining unexpected Precoding Matrix Indicators (PMIs) based on a comparison of previous reported PMIs with a current allocated DL precoding matrix.

In Example 17, the subject matter of Example 16 can optionally include that determining the decoding confidence comprises determining an overoptimistic Modulation and Coding Scheme (MCS) allocation based on a comparison of a current allocated DL MCS with a previous transmitted Channel Quality Indicator (CQI).

In Example 18, the subject matter of Example 17 can optionally include: using respective mismatch counters for determining the unexpected DL retransmission requests, the unexpected RIs, the unexpected PMIs and the overoptimistic MCS allocation.

In Example 19, the subject matter of Example 18 can optionally include: determining an overall UCI decoding confidence level based on a combined weighted averaging of the respective mismatch counters.

In Example 20, the subject matter of Example 19 can optionally include: determining a power scaling bias factor based on the overall UCI decoding confidence level.

In Example 21, the subject matter of Example 20 can optionally include that the power scaling bias factor is close to zero when the overall UCI decoding confidence level indicates low error rate on UCI decoding; and that the power scaling bias factor is close to one when the overall UCI decoding confidence level indicates a high error rate on UCI decoding.

In Example 22, the subject matter of any one of Examples 11-21 can optionally include: predicting a future decoding confidence of the BS based on a combination of at least one previously determined decoding confidence of the BS and a currently determined decoding confidence of the BS.

Example 23 is a power scaling controller for a User Equipment (UE), the power scaling controller comprising: an Uplink Control Information (UCI) decoding confidence estimator module, configured to determine a UCI decoding confidence level based on a decoding confidence metric with respect to a current received Downlink Control Information (DCI) and previous transmitted UCI; and a transmission power scaling controller module, configured to generate a power scaling for an uplink transmission based on the determined UCI decoding confidence level.

In Example 24, the subject matter of Example 23 can optionally include that the current received Downlink Control Information (DCI) comprises at least one of a current received New Data Indicator (NDI), information of current allocated layers, a current allocated Precoding Matrix Indicator (PMI), a current allocated DL Modulation and Coding Scheme (MCS).

In Example 25, the subject matter of Example 24 can optionally include that the previously transmitted UCI comprises at least one of a previously transmitted Acknowledgement (ACK) or Non-Acknowledgement (NACK), a previous transmitted PMI, a previous transmitted Rank Indicator (RI), a previous transmitted Channel Quality Indicator (CQI).

In Example 26, the subject matter of Example 25 can optionally include at least one of the following detectors: a first detector configured to detect an unexpected retransmission based on the current received NDI and the previous transmitted Acknowledgement (ACK) or Non-Acknowledgement (NACK); a second detector configured to detect a PMI mismatch based on the current allocated PMI and the previous transmitted PMI; a third detector configured to detect an RI mismatch based on the information of current allocated layers and the previous transmitted RI; and a fourth detector configured to detect an over-optimistic MCS based on the current allocated DL MCS and the previous transmitted CQI.

In Example 27, the subject matter of Example 26 can optionally include that each of the detectors comprises: a mismatch accumulator configured to accumulate a detected mismatch of the respective detector; and a time normalization module configured to normalize an output of the corresponding mismatch accumulator with respect to time.

In Example 28, the subject matter of Example 27 can optionally include: a weighted averaging module, configured to weight and combine the outputs of the time normalization modules to generate the UCI decoding confidence level.

In Example 29, the subject matter of Example 28 can optionally include that the weighted averaging module is configured to generate the UCI decoding confidence level within a range between zero and one.

In Example 30, the subject matter of any one of Examples 23-29 can optionally include that the transmission power scaling controller module is configured to determine a requested transmission power for a primary cell including the UCI and a requested transmission power for at least one secondary cell without a UCI.

In Example 31, the subject matter of Example 30 can optionally include that the transmission power scaling controller module is configured to determine the requested transmission powers according to 3GPP technical specification 36.213.

In Example 32, the subject matter of any one of Examples 30-31 can optionally include that the transmission power scaling controller module is configured to determine a power scaling bias factor based on the UCI decoding confidence level determined by the UCI decoding confidence estimator module.

In Example 33, the subject matter of Example 32 can optionally include that the transmission power scaling controller module is configured to determine the power scaling bias factor based on a predetermined relation with the UCI decoding confidence level.

In Example 34, the subject matter of any one of Examples 32-33 can optionally include that the transmission power scaling controller module is configured to determine the power scaling bias factor when a sum of the requested transmission powers exceeds a total configured maximum output power.

In Example 35, the subject matter of Example 34 can optionally include that the transmission power scaling controller module is configured to generate the power scaling for the uplink transmission of the primary cell based on the total configured maximum output power, the requested transmission power for the primary cell and the power scaling bias factor.

In Example 36, the subject matter of any one of Examples 34-35 can optionally include that the transmission power scaling controller module is configured to generate the power scaling for the uplink transmission of the at least one secondary cell based on the total configured maximum output power, the requested transmission power for the at least one secondary cell and the power scaling bias factor.

Example 37 is a User Equipment (UE), comprising: a radio frequency (RF) receiver, configured to receive a Downlink (DL) transmission comprising DL control information (DCI); an RF transmitter configured to transmit an Uplink (UL) transmission with adjustable power scaling; and a power scaling controller according to one of Examples 23 to 36, configured to adjust the power scaling of the RF transmitter.

In Example 38, the subject matter of Example 37 can optionally include: a DL demodulator and decoder, configured to provide the DCI based on demodulating and decoding the DL transmission; an UL encoder and modulator, configured to provide the UL transmission and a current UCI based on encoding and modulating UL data payload.

In Example 39, the subject matter of Example 38 can optionally include that the power scaling controller comprises a UCI memory configured to provide the previous transmitted UCI based on storing the current UCI.

Example 40 is a circuit arrangement for a mobile device, the circuit arrangement comprising: a receiver circuit, configured to receive a Downlink (DL) transmission comprising DL control information (DCI); a transmitter circuit configured to transmit an Uplink (UL) transmission with adjustable power scaling; and a power scaling controller circuit configured to adjust the power scaling of the transmitter circuit based on a decoding confidence metric with respect to a current received Downlink Control Information (DCI) and previous transmitted UCI.

In Example 41, the subject matter of Example 40 can optionally include: an Uplink Control Information (UCI) decoding confidence estimator circuit, configured to determine a UCI decoding confidence level based on the decoding confidence metric with respect to the current received DCI and the previous transmitted UCI; and a transmission power scaling controller circuit, configured to generate the power scaling for the transmitter circuit based on the determined UCI decoding confidence level.

Example 42 is a mobile communication system, comprising: a transceiver, configured to receive a Downlink (DL) transmission from a base station (BS) and to transmit an Uplink (UL) transmission to the BS; and a controller, configured to determine a decoding confidence of the BS based on a decoding confidence metric with respect to the received DL transmission and to generate a power scaling for the UL transmission based on the determined decoding confidence, wherein the transceiver is configured to transmit the UL transmission based on the power scaling generated by the controller.

In Example 43, the subject matter of Example 42 can optionally include that the decoding confidence metric is based on counting unexpected DL retransmission requests.

Example 44 is a device for power scaling of a User Equipment (UE), the device comprising: means for receiving a Downlink (DL) transmission from a base station (BS); means for determining a decoding confidence of the BS based on a decoding confidence metric with respect to the received DL transmission; means for generating a power scaling for an Uplink (UL) transmission to the BS based on the determined decoding confidence; and means for transmitting the UL transmission to the BS based on the generated power scaling.

In Example 45, the subject matter of Example 44 can optionally include that the decoding confidence indicates a confidence of decoding an Uplink Control Information (UCI) by the BS, the UCI comprised in the UL transmission.

Example 46 is a computer readable non-transitory medium on which computer instructions are stored which when executed by a computer cause the computer to perform the method of any one of Examples 11 to 22.

In Example 47 is a UE device which communicates with a base station through 2-way links (uplink and downlink) and estimates the decoding performance of uplink control information (UCI) received in base station side based on downlink control information (DCI) received in UE side.

In Example 48, the subject matter of Example 47 can optionally include that the UE device counts the mismatches of a sub-set of parameters from currently received DCI and a sub-set of parameters from previous transmitted UCI.

In Example 49, the subject matter of any one of Examples 47-48 can optionally include that the UE device estimates the overall UCI decoding confidence level by combining the mismatch counts from the sub-set of parameters from UCI and DCI.

In Example 50, the subject matter of any one of Examples 47-49 can optionally include that the UE device predicts the future UCI decoding confidence level by combining the previous estimated UCI confidence level and current estimated UCI confidence level.

In Example 51, the subject matter of any one of Examples 47-50 can optionally include that the UE device dynamically scales the transmission power allocation over different uplink carriers based on an adaptive scaling bias factor and the scaling bias factor is determined by the estimated UCI decoding confidence level.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1-25. (canceled)

26. A User Equipment (UE), comprising:
a transceiver, configured to receive a Downlink (DL) transmission from a base station (BS) and to transmit an Uplink (UL) transmission to the BS; and
a controller, configured to determine a decoding confidence of the BS based on a decoding confidence metric with respect to the received DL transmission and to generate a power scaling for the UL transmission based on the determined decoding confidence,
wherein the transceiver is configured to transmit the UL transmission based on the power scaling generated by the controller.

27. The UE of claim 26,
wherein the decoding confidence metric is based on counting unexpected DL retransmission requests.

28. The UE of claim 26,
wherein the decoding confidence metric is based on counting instances when the BS did not follow one of precoding matrix indication (PMI) or rank indication (RI) reports sent by the UE.

29. The UE of claim 26,
wherein the decoding confidence metric is based on counting instances when the BS schedules an over-optimistic modulation and coding set (MCS) allocation.

30. The UE of claim 26,
wherein the controller is configured to reduce the power scaling for the UL transmission when determining an increased decoding confidence of the BS and to increase the power scaling for the UL transmission when determining a reduced decoding confidence of the BS.

31. The UE of claim 26,
wherein the decoding confidence metric is based on a confidence of decoding Uplink Control Information (UCI) by the BS.

32. The UE of claim 31,
wherein the transceiver is configured to transmit the UL transmission comprising the UCI unprotected by error correction coding.

33. The UE of claim 31,
wherein the controller is configured to generate the power scaling in a carrier aggregation scenario for an UL transmission comprising a first UL transmission directed to a primary cell and at least one secondary UL transmission directed to at least one secondary cell, wherein the first UL transmission carries the UCI.

34. The UE of claim 33,
wherein the controller is configured to down-scale the power scaling for the first UL transmission and to upscale the power scaling for the at least one secondary UL transmission when a total configured maximum output power of the UL transmission crosses a threshold.

35. The UE of claim 33,
wherein the controller is configured to reduce the power scaling for the first UL transmission and to correspondingly increase the power scaling for the at least one secondary UL transmission when determining an increased decoding confidence of the BS and to increase the power scaling for the first UL transmission and to correspondingly reduce the power scaling for the at least one secondary UL transmission when determining a reduced decoding confidence of the BS.

36. A method for power scaling of a user equipment (UE), the method comprising:
receiving a Downlink (DL) transmission from a base station (BS);
determining a decoding confidence of the BS based on a decoding confidence metric with respect to the received DL transmission;
generating a power scaling for an Uplink (UL) transmission to the BS based on the determined decoding confidence; and
transmitting the UL transmission to the BS based on the generated power scaling.

37. The method of claim 36,
wherein the decoding confidence indicates a confidence of decoding an Uplink Control Information (UCI) by the BS, the UCI comprised in the UL transmission.

38. The method of claim 37,
wherein the decoding confidence metric is based on Downlink Control Information (DCI) comprised in the DL transmission.

39. The method of claim 38,
wherein determining the decoding confidence comprises determining unexpected DL retransmission requests based on a comparison of a previously reported Acknowledgement (ACK) or Non-Acknowledgement (NACK) in the UCI with a current indicated New Data Indicator (NDI) in the DCI.

40. The method of claim 39,
wherein determining the decoding confidence comprises determining unexpected Rank Indicators (RIs) based on a comparison of assigned DL layers with previously reported RIs.

41. The method of claim 40,
wherein determining the decoding confidence comprises determining unexpected Precoding Matrix Indicators (PMIs) based on a comparison of previous reported PMIs with a current allocated DL precoding matrix.

42. The method of claim 41,
wherein determining the decoding confidence comprises determining an overoptimistic Modulation and Coding Scheme (MCS) allocation based on a comparison of a current allocated DL MCS with a previous transmitted Channel Quality Indicator (CQI).

43. The method of claim 42, comprising:
using respective mismatch counters for determining the unexpected DL retransmission requests, the unexpected RIs, the unexpected PMIs and the overoptimistic MCS allocation.

44. The method of claim 43, comprising:
determining an overall UCI decoding confidence level based on a combined weighted averaging of the respective mismatch counters.

45. The method of claim 44, comprising:
determining a power scaling bias factor based on the overall UCI decoding confidence level.

46. The method of claim 45,
wherein the power scaling bias factor is close to zero when the overall UCI decoding confidence level indicates low error rate on UCI decoding; and
wherein the power scaling bias factor is close to one when the overall UCI decoding confidence level indicates a high error rate on UCI decoding.

47. The method of claim 36, comprising:
predicting a future decoding confidence of the BS based on a combination of at least one previously determined decoding confidence of the BS and a currently determined decoding confidence of the BS.

48. A power scaling controller for a User Equipment (UE), the power scaling controller comprising:
an Uplink Control Information (UCI) decoding confidence estimator module, configured to determine a UCI decoding confidence level based on a decoding confidence metric with respect to a current received Downlink Control Information (DCI) and previous transmitted UCI; and
a transmission power scaling controller module, configured to generate a power scaling for an uplink transmission based on the determined UCI decoding confidence level.

49. The power scaling controller of claim 48,
wherein the current received Downlink Control Information (DCI) comprises at least one of a current received New Data Indicator (NDI), information of current allocated layers, a current allocated Precoding Matrix Indicator (PMI), a current allocated DL Modulation and Coding Scheme (MCS).

50. The power scaling controller of claim 49,
wherein the previously transmitted UCI comprises at least one of a previously transmitted Acknowledgement (ACK) or Non-Acknowledgement (NACK), a previous transmitted PMI, a previous transmitted Rank Indicator (RI), a previous transmitted Channel Quality Indicator (CQI).
